(19) United States
(12) Patent Application Publication
(10) Pub. No.: US 2006/0070210 A1
(43) Pub. Date: Apr. 6, 2006

(54) Counter balanced hinge assembly

(75) Inventors: Paul Amdahl, Monument, CO (US); David S. Kim, Irvine, CA (US); Gerson Goldberg, Menlo Park, CA (US); Bob Riccomini, Saratoga, CA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(73) Assignee: Gateway

(21) Appl. No.: 11/240,245

(22) Filed: Sep. 30, 2005

Related U.S. Application Data
(60) Provisional application No. 60/614,560, filed on Sep. 30, 2004.
(60) Provisional application No. 60/618,874, filed on Oct. 14, 2004.

(51) Int. Cl. E05F 1/08

(52) U.S. Cl. 16/288

(57) ABSTRACT

A hinge assembly includes a base, a link, a spring, and a pair of clutches. The spring attaches to the link, and the link attaches to an object to be supported, e.g., an LCD monitor. The clutches resist pivotal motion between the link and the base, and between the object and the link, wile the spring is in tension and balances the weight of the object. One or more additional combinations of these elements can be placed in parallel, joined by anti-sway bars, to further stabilize the assembly.

This application is related to and claims priority under 35 U.S.C. § 119 to U.S. provisional patent application No. 60/614,560, filed 30 Sep. 2004, bearing attorney docket number P2010US00, entitled “Display Hinge Assembly with An Adjustable Counter Balance”, by Paul Amdahl, David Kim, Robert Riccomini, and Gerson Goldberg, the entirety of which is incorporated by reference herein.

### BACKGROUND OF THE INVENTION

1. Field of the Invention

The present invention relates to hinge assemblies, and more specifically to such assemblies used to support visual displays such as computer monitors and LCD television monitors.

2. Brief Description of the Related Art

Hinges or clutches have in the past been used to hold an LCD's position in a vertical (up-down) position and a tilted position. One problem that has been encountered with such prior systems using clutches is the difficulty in the user's feel of up-down movement; because the clutches are counter-balancing the overall weight of the LCD assembly (e.g., 15″˜4.6 lbs, 17″˜7.3 lbs, and 19″˜10.3 lbs), the torque values of the clutches need to be quite high. Thus, in upward movement, the user has to not only overcome the torque value of the clutches, but also the overall weight of the LCD assembly.

There remains a need, therefore, for improvements in hinge assemblies that assist a user in adjusting the height and/or tilt of the object to which the hinge is attached.

### SUMMARY OF THE INVENTION

According to a first aspect of the invention, a hinge assembly useful for supporting an object includes a base, an attachment element configured and arranged to attach to said object, a link extending between the base and the attachment element, a tension element extending between the base and the link, and a resistive torque supplying device attached to the base and pivotally attached to the link, wherein the resistive torque supplying device inhibits the link pivoting relative to the base.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus, given only by way of example, and with reference to the accompanying drawings, in which:

FIG. 1 illustrates a right top rear perspective view of portions of an exemplary embodiment of a hinge assembly in accordance with the principles of the present invention; and

FIG. 2 illustrates a right side elevational view of portions of the exemplary embodiment illustrated in FIG. 1.

### DETAILED DESCRIPTION OF EXEMPLARY EMBODIMENTS

Referring to the drawing figures, like reference numerals designate identical or corresponding elements throughout the several figures.

A counter balanced hinge assembly in accordance with principles of the present invention assists the up-down movement of a display, e.g., a LCD assembly, thus giving a user very smooth feel during up-down movement.

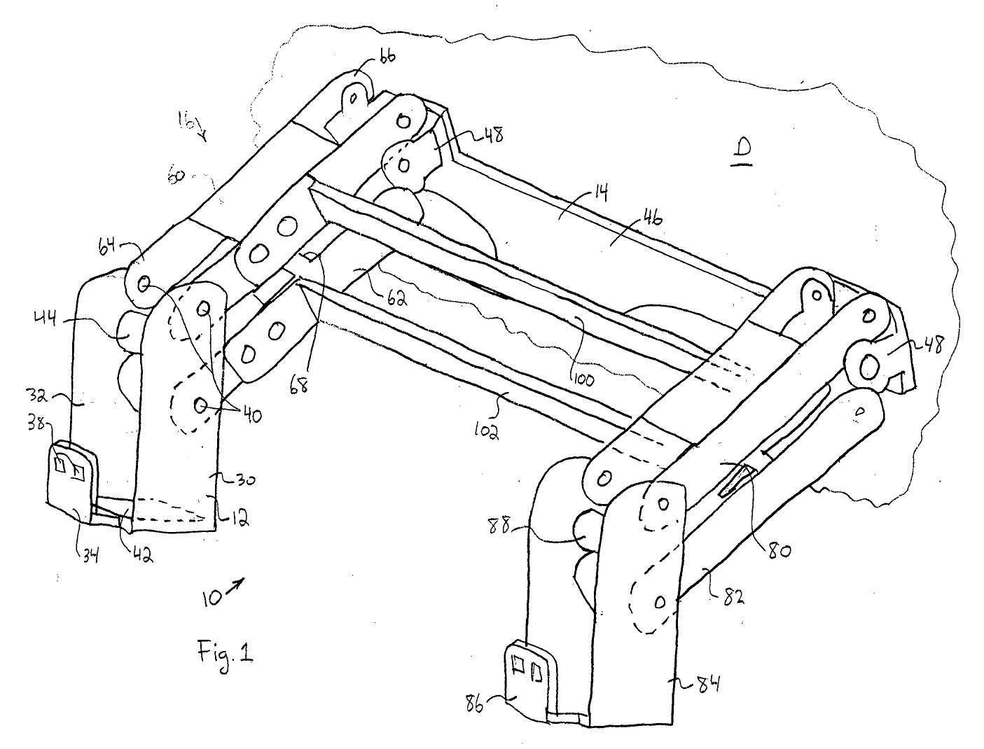

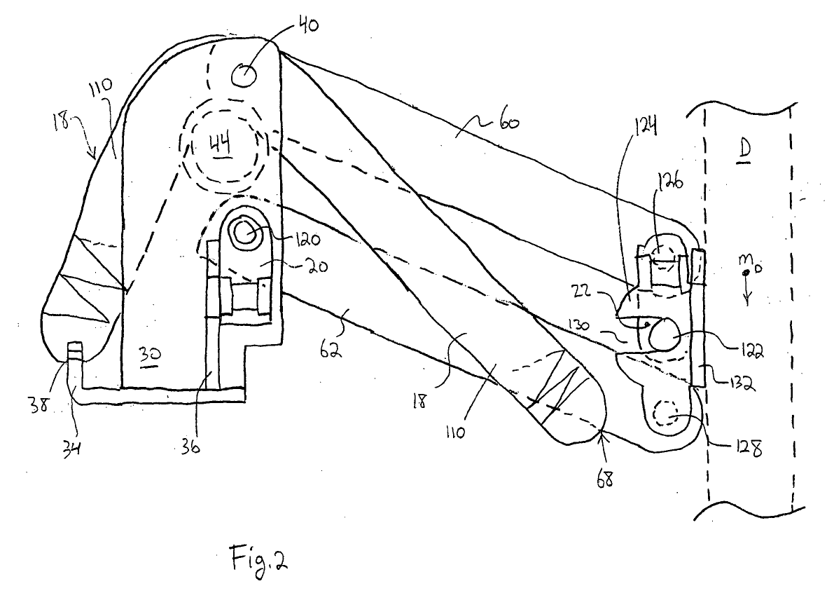

Turning now to the drawing figures, a first exemplary embodiment of a hinge assembly in accordance with the principles of the present invention is illustrated. Throughout the following description, reference will be simultaneously made to both FIGS. 1 and 2, as different portions of the exemplary hinge assembly have been excluded from each drawing figures to aid in a clearer understanding of the principles of the invention in general, and of the exemplary hinge assembly specifically.

FIGS. 1 and 2 illustrate an exemplary hinge assembly 10 embodying principles of the present invention. The hinge 10 includes a base 12, a display attachment element 14, movable link 16 between the base and the display attachment element, a tension member 18, and resistive torque supplying elements 20, 22. While the following description details exemplary embodiments of structures which together act as a hinge assembly, those of ordinary skill in the art will readily appreciate that other structures can be employed to perform the same or similar functions as those described herein without departing from the principles of the present invention.

The base 12 includes a base bottom 42, a first base half 30, and a second base half 32 spaced from the first base half. An upstanding flange 34 is attached to the base 12, and includes an attachment point 38, e.g., one or more holes, a purpose of which will be described in greater detail below. A control bar 44 extends between the first 30 and second 32 base halves, which provides a tension direction transition point as also described in greater detail below. The control bar 44 also enables the tension member 18 to be longer than would otherwise be possible without the control bar, because the tension member passes over the control bar between the two points of attachment of the tension member to the other structures of the assembly. In this manner, exemplary embodiments of assemblies according to principles of the present invention can be more finely tuned, including longer tension members with higher effective spring rates, than embodiments of the present invention in which the tension member does not pass over the control bar 44.

The display attachment element 14 can take any of numerous forms, an example of which includes a bar or plate 46 to which a display D is firmly attached by known ways. The display D has a mass M, the gravitational force from which is, at least in part, counteracted by structures described herein.

The movable link 16 is attached to the base 12 at a base end 64 and to the display attachment element 14 at a display end 66, and joins the two together. According to an exemplary embodiment of the present invention, the movable link 16 includes at least a parallel pair of bars, including an upper bar 60 and a lower bar 62. In the exemplary embodiment illustrated in the figures, each bar 60, 62 includes spaced apart portions at both the base end 64 and the display end 66, and are pivotally attached to the base halves 30, 32 at pivot points 40, and directly or indirectly to the display attachment element 14 at the display end 66. As can be seen in both drawing figures, an attachment point 68 is provided, e.g., on the lower bar 62, for attaching a tension member to the movable link 16; the attachment point can be located anywhere on the link in accordance with the present invention. A clutch attachment point 48 is provided on the display attachment element 14, as will be described in greater detail below.

While a single base/link/display attachment/tension element/resistive torque supplying element combination can support a display D, the present invention extends to the provision of more than one such combination, acting in parallel with each other to support a display D. As illustrated in the drawing figures, a second combination of these elements is illustrated spaced apart from the first set of these elements, bridged by the display attachment element 14; of course, if the display D itself is sufficiently rigid, the display attachment element need not bridge the two sets of elements, and the two or more attachment elements can separately and independently attach to the display D, in accordance with the principles of the present invention.

The second base/link/display attachment/tension element/resistive torque supplying element combination includes an upper bar 80, lower bar 82, base 84, flange 86, control bar 88, and the other structures described herein. Thus, the second set is, essentially, a duplicate of the first, and preferably includes the same elements. Optionally, one or more anti-sway bars 100, 102, extend between the movable links 16, and inhibit or prevent the parallel sets of structures from moving out of parallel planes. While the bars 100, 102 are illustrated as extending between both upper and lower bars 60, 62, other embodiments in accordance with the principles of the present invention include only a single anti-sway bar joining portions of the movable links 16. Thus, as illustrated in the exemplary embodiment of the drawing figures, a four-bar linkage links the bases 12, 84, and the display D.

With more specific reference to FIG. 2, tension element 18 and resistive torque supplying elements 20, 22 are illustrated. In general terms, the tension element 18 provides a tension force between the base 12 and the link 16, while the resistive torque supplying element 20 resists, but does not prevent, pivotal motion between the link 16 and the base 12, and the resistive torque supplying element 22 resists, but does not prevent, pivotal motion between the link 16 and the display attachment element 14. In this manner, the tension element 18 can provide most, or all, of the force necessary to offset the gravitational force of the display D, optionally assisted by the force provided by resistive torque supplying element 20. The resistive torque supplying element 20 provides a force resisting up and down motion of the display D, while the resistive torque supplying element 22 provides a force resisting tilting or rotation of the display D at the attachment point 48.

The tension element 18 can be, according to the principles of the present invention, embodied in one or more of numerous structures. By way of example and not of limitation, one or more tension springs 110 can be stretched, preferably with a pre-tension, between the base 12, e.g., at the attachment point 38, and the link 16, e.g., at the attachment point 68. When the attachment point 38 is provided near the bottom of the base 12, it is advantageous to extend the tension element 18 over the control bar 44, thus providing the tension force vector with an upward component that, by appropriate selection of the spring rate of the tension element 18, at least partially, and preferably completely compensates for the gravitational force on the display D.

As can be seen in FIG. 2, the base includes an internal, that is, between the two halves 30, 32, upstanding flange 36 to which the resistive torque supplying element 20 is firmly attached. The resistive torque supplying element 20 is pivotally attached to the link 16, e.g., at the lower bar 62, at an attachment point 120. Thus, the link 16 can pivot at the resistive torque supplying element 20, but only after a preselected rotational force (moment) is applied to the display end 66 of the link 16. Thus, the resistive torque supplying element 20 stabilizes the interaction between the tension element 18 and the display D, and optionally can provide some of the force necessary to offset the weight of the display.

The display end 66 of the link 16 is attached to a resistive torque supplying element 22 in an optionally different manner; the resistive torque supplying element 22 is illustrated in part in broken lines, and exemplarily has the same general shape as resistive torque supplying element 20. A link 124 is provided between the upper bar 60 and the lower bar 62, and includes a slot 130. The resistive torque supplying element 22 is attached to the attachment point 48 on the display attachment element 14 at the pivot point 122, while other portions of the resistive torque supplying element 22 extend into and are retained in the slot 130. In this manner, the display D can be tilted about the pivot point 122, once sufficient force/moment is applied to the display to overcome the force of the resistive torque supplying element 22, while the link 124 keeps the upper bar 60 and lower bar 62 parallel at pivot points 126, 128.

The resistive torque supplying elements 20, 22, preferably include a friction clutch such as those commonly commercially available in numerous sizes and friction force values. Further optionally, adjustable friction clutches can be provided, by which the statics of and motion between the structures described herein can be finely tuned. The tension element 18 can include one or more tension springs. Preferably, although not necessarily, the elements 20, 22, supply the same amount of resistive torque, and/or tension elements 18 supply the same amount of force, so the motion of the hinge is substantially even.

Further optionally, the display D can be replaced with any other object for which it is useful to control a height and/or a tilt, including, but not limited to, computing devices, lamps, mirrors, static displays, signs, chalkboards, whiteboards, cameras, etc.

While the invention has been described in detail with reference to exemplary embodiments thereof, it will be apparent to one skilled in the art that various changes can be made, and equivalents employed, without departing from the scope of the invention. Each of the aforementioned documents is incorporated by reference herein in its entirety.

What is claimed is:

1. A hinge assembly useful for supporting an object, the hinge assembly comprising:
a base;
an attachment element configured and arranged to attach to said object;
a link extending between the base and the attachment element;
a tension element extending between the base and the link; and
a resistive torque supplying device attached to the base and pivotally attached to the link, wherein the resistive torque supplying device inhibits the link pivoting relative to the base.

2. The hinge assembly in accordance with claim 1, wherein the resistive torque supplying device is a first resistive torque supplying device, and further comprising:
a second resistive torque supplying device attached to the attachment element and pivotally attached to the link, wherein the second resistive torque supplying device inhibits the attachment element pivoting relative to the link.

3. The hinge assembly in accordance with claim 2, wherein the resistive torque supplying device comprises a friction clutch.

4. The hinge assembly in accordance with claim 1, wherein the resistive torque supplying device comprises a friction clutch.

5. The hinge assembly in accordance with claim 1, wherein the link comprises two parallel bars.

6. The hinge assembly in accordance with claim 1, further comprising:
a control bar attached to the base, the tension element stretched over and changing directions at the control bar.

7. The hinge assembly in accordance with claim 1, wherein the tension element comprises at least one tension spring.

8. The hinge assembly in accordance with claim 1, wherein the base is a first base, the attachment element is a first attachment element, the link is a first link, the tension element is a first, and the a resistive torque supplying device is a first torque supplying device, and further comprising:
a second base spaced from the first base;
a second attachment element configured and arranged to attach to said object, and spaced from the first attachment element;
a second link extending between the second base and the second attachment element, and spaced from the first link;
a second tension element extending between the second base and the second link; and
a second resistive torque supplying device attached to the second base and pivotally attached to the second link, wherein the second resistive torque supplying device inhibits the second link pivoting relative to the second base.

9. The hinge assembly in accordance with claim 8, further comprising:
at least one anti-sway bar extending between and connecting the first link and the second link.

10. The hinge assembly in accordance with claim 8, further comprising:
a third resistive torque supplying device attached to the first attachment element and pivotally attached to the first link, wherein the third resistive torque supplying device inhibits the first attachment element pivoting relative to the first link.

11. The hinge assembly in accordance with claim 10, further comprising:
a fourth resistive torque supplying device attached to the second attachment element and pivotally attached to the second link, wherein the fourth resistive torque supplying device inhibits the second attachment element pivoting relative to the second link.

12. The hinge assembly in accordance with claim 11, wherein at least one of the first, second, third, and fourth resistive torque supplying devices comprise a friction clutch.

13. The hinge assembly in accordance with claim 8, wherein at least one of the first and second resistive torque supplying devices comprises a friction clutch.

14. The hinge assembly in accordance with claim 8, wherein the second link comprises two parallel bars.

15. The hinge assembly in accordance with claim 8, further comprising:
control bars attached to each of the first base and the second base, the first tension element stretched over and changing directions at a first control bar, the second tension element stretched over and changing directions at a second control bar.

16. The hinge assembly in accordance with claim 8, wherein at least one of the first and second tension elements comprise at least one tension spring.

17. The hinge assembly in accordance with claim 8, wherein both of the first and second tension elements comprise at least one tension spring.

18. The hinge assembly in accordance with claim 8, further comprising:
an attachment plate comprising the first attachment element and the second attachment element.

19. The hinge assembly in accordance with claim 8, further comprising:
said object attached to the first attachment element and the second attachment element, the object having a mass;
wherein the first tension element and the second tension element have tensions together selected to substantially balance the weight of the object.

20. The hinge assembly in accordance with claim 1, further comprising:
said object attached to the attachment element, the object having a mass;
wherein the tension element has a tension selected to substantially balance the weight of the object.
